(19) United States
(12) Patent Application Publication
(10) Pub. No.: US 2009/0066588 A1
(43) Pub. Date: Mar. 12, 2009

(54) Case structure of electronic device

(75) Inventors: Yu-Chiang Cheng, Taipei City (TW); Ping-Cheng Chang, Pingtung County (TW); Cheng-Zing Chou, Tainan County (TW)

Correspondence Address: QUINTERO LAW OFFICE, PC, 2210 MAIN STREET, SUITE 200, SANTA MONICA, CA, 90405, US

(73) Assignee: Mitac Technology Corp.

(21) Appl. No.: 11/898,314

(22) Filed: Sep. 11, 2007

(51) Int. Cl. H01Q 1/24

(52) U.S. Cl. 343/702

(57) ABSTRACT

A case structure of an electronic device is used for directly integrating an antenna of a signal transceiver circuit and a case of the electronic device, so as to improve a space utilization rate of the electronic device. At least one trench pattern is formed on a specific region of the metal case of the electronic device. When the metal case is electrically coupled to the signal transceiver circuit of the electronic device, the metal case and the trench pattern constitute at least one antenna of the electronic device.

### BACKGROUND

1. Field of Invention

The present invention relates to a case structure. More particularly, the present invention relates to a case structure of an electronic device.

2. Related Art

With the development of wireless communication technology, recently, the wireless communication technology has been widely applied in various fields, such as video program, wireless communication, and satellite positioning. In order to cater to the requirement of the electronic device, the signal transceiver circuit is increasingly reduced, and is integrated in the electronic device, so as to improve the using convenience.

However, with the requirement that the wireless communication functions (e.g. mobile communication function, global satellite positioning function, wireless network function, or digital broadcasting function etc) of the electronic device become increasingly diversified, after each signal transceiver circuit is integrated into the electronic device, it is necessary for the manufacturers of the electronic device to dispose the respective antenna in the residual space of the electronic device. The antenna is one of the important elements affecting the quality of the wireless communication, so when the volume of the electronic device increasingly develops a design trend of being short, small, light, and thin, for the manufacturers of the electronic device, it is a problem to be solved by researcher how to integrate the antenna of various signal transceiver circuits in the electronic device.

Referring to Taiwan Patent Publication No. 200610228, an antenna module in an electronic device is disclosed, which is capable of minimizing the occupied space, thereby improving the freedom of the electronic device disposition structure without changing the property, increasing the space utilization rate of the electronic device, and realizing the miniaturization and the versatility of the electronic device. The patent application also provides an electronic device having the antenna module. The antenna module includes a printed circuit board made of a flexible nonconductive material; an antenna element disposed on an assigned position of an upper surface of the printed circuit board, and a ground line formed on the printed circuit board, connected to a ground end of the antenna element, and having a junction portion formed on an end of the ground line; a feeder formed on the printed circuit board, connected to connect to a signal end of the antenna element, and having a junction potion formed on an end of the feeder; and a passive line formed on the printed circuit board, parallelly connected with the feeder, and having an assigned length. The junction portion of the ground line and the feeder is joined at an assigned position of the wireless electronic device, and a part of the antenna module having the antenna element disposed on the printed circuit board is formed outside of the apparatus.

Although in the patent application, the space utilization rate of the electronic device has been increased, a part of the antenna module is disposed outside of the electronic device, the original whole volume of the electronic device is increased, and the hidden antenna design requirement is not satisfied, so it still has a room to be improved.

### SUMMARY OF THE INVENTION

In view of the above problems, the present invention provides a case structure of an electronic device, which directly integrates an antenna of a signal transceiver circuit and a case, so as to fully use the space of the electronic device, thereby improving the space utilization rate of the electronic device.

In the case structure of the electronic device according to the present invention, at least one trench pattern is formed on a specific region of a metal case used for holding the internal circuit of the electronic device. When the metal case is electrically coupled to the signal transceiver circuit of the electronic device, the metal case and the trench pattern constitute at least one antenna of the electronic device.

In the case structure of the electronic device, the combination of the case and the metal layer forms a structure and an operating principle similar to the slot antenna. In appearance, the antenna of the electronic device is adhered on the case and is partially exposed. The internal space of the electronic device is not occupied too much, in addition, because of the structural property of the partial exposed antenna, the gain of the antenna formed according to the present invention is better than the gain of the conventional built-in antenna.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1A is a schematic sectional structural view of a first embodiment according to the present invention;

FIG. 1B is a schematic sectional structural view of a second embodiment according to the present invention;

FIG. 1C is a schematic sectional structural view of a third embodiment according to the present invention;

FIG. 1D is a schematic sectional structural view of a fourth embodiment according to the present invention;

FIG. 1E is a schematic sectional structural view of a fifth embodiment according to the present invention;

FIG. 1F is a schematic sectional structural view of a sixth embodiment according to the present invention;

FIG. 2A is a schematic view of the appearance of the electronic device according to the embodiment of the present invention;

FIG. 2B is a schematic view of the appearance of the electronic device according to another embodiment of the present invention;

FIG. 3A is a schematic top view of the first embodiment according to the present invention;

FIG. 3B is a schematic top view of the fifth embodiment according to the present invention;

FIG. 4 is a schematic view of the reflection loss of the embodiment according to the present invention;

FIG. 5A is a radiation field pattern view of an H plane of the embodiment according to the present invention;

FIG. 5B is a radiation field pattern view of the H plane of the embodiment according to the present invention;

FIG. 5C is a radiation field pattern view of the H plane of the embodiment according to the present invention;

FIG. 5D is a radiation field pattern view of the H plane of the embodiment according to the present invention;

FIG. 5E is a radiation field pattern view of the H plane of the embodiment according to the present invention;

FIG. 5F is a radiation field pattern view of the H plane of the embodiment according to the present invention;

FIG. 5G is a radiation field pattern view of the H plane of the embodiment according to the present invention;

FIG. 6A is a radiation field pattern view of an E1 plane of the embodiment according to the present invention;

FIG. 6B is a radiation field pattern view of the E1 plane of the embodiment according to the present invention;

FIG. 6C is a radiation field pattern view of the E1 plane of the embodiment according to the present invention;

FIG. 6D is a radiation field pattern view of the E1 plane of the embodiment according to the present invention;

FIG. 6E is a radiation field pattern view of the E1 plane of the embodiment according to the present invention;

FIG. 6F is a radiation field pattern view of the E1 plane of the embodiment according to the present invention;

FIG. 6G is a radiation field pattern view of the E1 plane of the embodiment according to the present invention;

FIG. 7A is a radiation field pattern view of an E2 plane of the embodiment according to the present invention;

FIG. 7B is a radiation field pattern view of the E2 plane of the embodiment according to the present invention;

FIG. 7C is a radiation field pattern view of the E2 plane of the embodiment according to the present invention;

FIG. 7D is a radiation field pattern view of the E2 plane of the embodiment according to the present invention;

FIG. 7E is a radiation field pattern view of the E2 plane of the embodiment according to the present invention;

FIG. 7F is a radiation field pattern view of the E2 plane of the embodiment according to the present invention; and

FIG. 7G is a radiation field pattern view of the E2 plane of the embodiment according to the present invention.

### DETAILED DESCRIPTION OF THE INVENTION

A case structure of an electronic device according to the present invention is used for accommodating an internal circuit of the electronic device. Herein, the electronic device can be, but not limited to, personal digital assistant (PDA), mobile phone, smart phone, PDA phone, notebook computer or the like. The accompanying drawings are used for providing reference and illustration, but not for limiting the present invention.

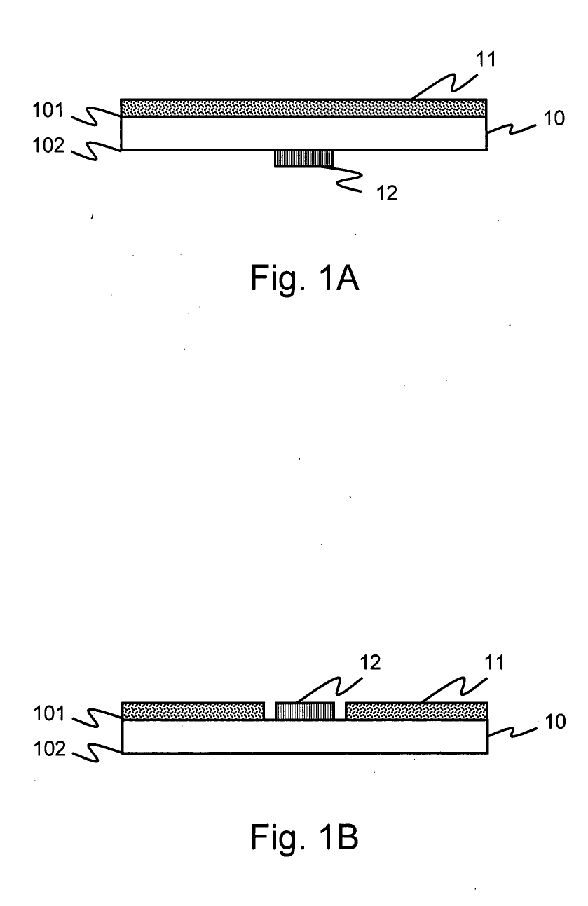

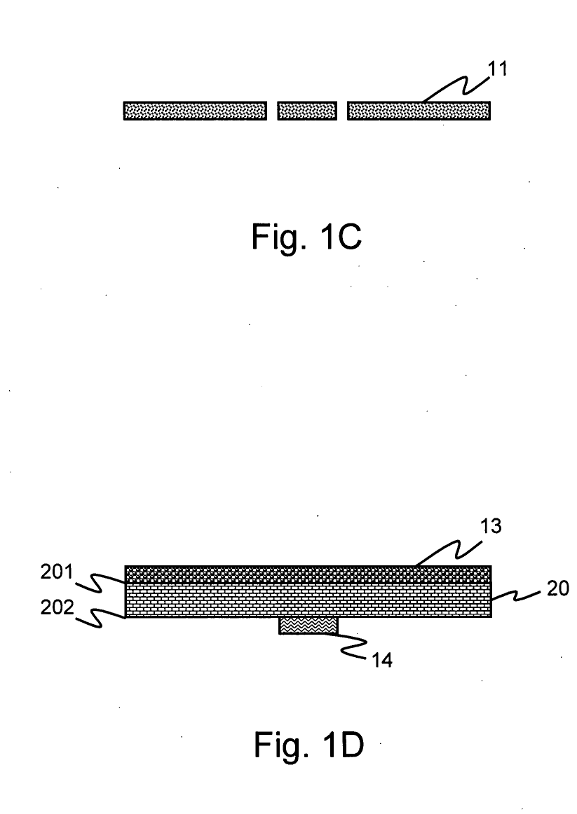

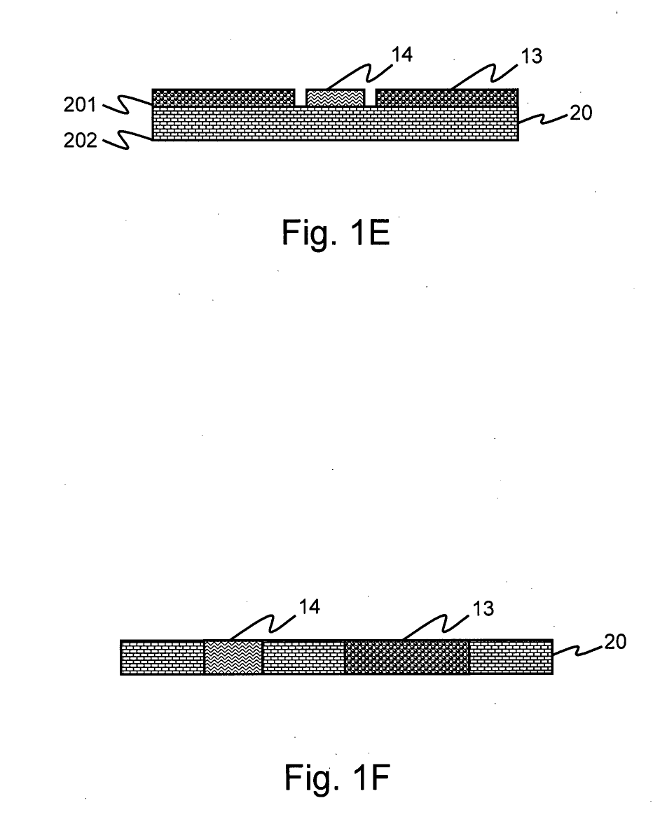

Referring to FIG. 1A, a schematic sectional structural view of a first embodiment according to the present invention is shown. As shown in FIG. 1A, the case structure of the present invention includes a dielectric layer 10, a metal case 11, and a metal layer 12.

The dielectric layer 10 has a first surface 101 and a second surface 102, and the dielectric layer 10 can be, for example, ceramic material.

The metal case 11 is used for holding the internal circuit (not shown) and is disposed on the first surface 101 of the dielectric layer 10 to serve as an antenna ground portion of the electronic device. In each embodiment of the present invention, the antenna includes a signal radiation portion for radiating a signal output by a signal transceiver circuit of the internal circuit (not shown) in the electronic device to an exterior of the electronic device, or for receiving a wireless signal from the exterior; a signal feeding portion electrically coupled to the signal transceiver circuit, for receiving the signal output by the signal transceiver circuit and transmitting the signal to the signal radiation portion, or transmitting the wireless signal received by the signal radiation portion to the signal transceiver circuit; a signal ground portion disposed around the signal radiation portion to serve as a ground loop of the antenna. The metal case 11 can be, for example, made of a single metal or an alloy material of titanium, aluminum, silver, copper, nickel, iron, cobalt, magnesium, or platinum.

In addition, in each embodiment of the present invention, each antenna is electrically coupled to respective corresponding signal transceiver circuit, so as to perform the transferring and processing operations of the wireless signal.

The metal layer 12 is disposed on the second surface 102 of the dielectric layer 10 to serve as the antenna signal feeding portion and the antenna radiation portion of the electronic device, and the antenna signal feeding portion is a 50 ohm microstrip line. The metal layer 12 can be, for example, made of a single metal or an alloy material of titanium, aluminum, silver, copper, nickel, iron, cobalt, magnesium, or platinum.

Referring to FIG. 1B, a schematic sectional structural view of a second embodiment according to the present invention is shown. The difference between the second embodiment and the first embodiment is that both of the metal case 11 and the metal layer 12 in the second embodiment are disposed on the first surface 101 of the dielectric layer 10. The remaining material parts in the second embodiment are the same as those in the first embodiment, so they are not described here.

Referring to FIG. 1C, a schematic sectional structural view of a third embodiment according to the present invention is shown. The difference between the third embodiment and the second embodiment is that in the third embodiment, the metal case 11 is not disposed on the dielectric layer 10, and the metal layer 12 does not exist. One or more trench patterns are formed on the metal case 11 by means of laser cutting, chemical etching, or punching injection etc. When the metal case 11 is electrically coupled to the signal transceiver circuit of the electronic device; the metal case 11 constitutes the antenna of the electronic device, in which the structure of the trench pattern is used to match a line impedance of the antenna, and thus the line impedance of the antenna is adjusted by designing the shape and the size of the trench pattern. The remaining material parts are the same as those of the second embodiment, so they are not described here.

Referring to FIG. 1D, a schematic sectional structural view of a fourth embodiment according to the present invention is shown. As shown in FIG. 1D, the case structure of the present invention includes a non-metallic case 20, a first metal layer 13, and a second metal layer 14.

The non-metallic case 20 has a first surface 201 and a second surface 202, in which the non-metallic case 20 can be, for example, plastic steel, acrylonltrile-butadiene-styreneresin (ABS), plastic (e.g. polyethylene (PE), high density polyethylene (HDPE), ultra-high molecular weight polyethylene (UHMPE), polypropylene (PP), polystyrene (PS), ABS, ethylene-vinyl acetate copolymer (EVA), polyamide (PA), poly(ethylene terephthalate) (PET), and polyvinyl chloride (PVC) etc.).

The first metal layer 13 is disposed on the first surface 201 of the non-metallic case 20 to serve as the antenna ground portion of the electronic device. The first metal layer 13 can be, for example, made of a single metal, such as titanium, aluminum, silver, copper, nickel, iron, cobalt, magnesium, or platinum, or an alloy material of titanium, aluminum, silver, copper, nickel, iron, cobalt, magnesium, or platinum.

The second metal layer 14 is disposed on the second surface 202 of the non-metallic case 20 to serve as the antenna signal feeding portion and the antenna radiation portion of the electronic device, and the antenna signal feeding portion is a 50 ohm microstrip line. The second metal layer 14 can be, for example, made of the single metal or the alloy material of titanium, aluminum, silver, copper, nickel, iron, cobalt, magnesium, or platinum.

Referring to FIG. 1E, a schematic sectional structural view of a fifth embodiment according to the present invention is shown. The difference of between fifth embodiment and the fourth embodiment is that both of the first metal layer 13 and the second metal layer 14 in the fifth embodiment are disposed on the first surface 201 of the non-metallic case 20. The remaining material parts are the same as those of the fourth embodiment, so they are not described here.

Referring to FIG. 1F, a schematic sectional structural view of a sixth embodiment according to the present invention is shown. The difference between the sixth embodiment and the fifth embodiment is that the non-metallic case 20 in the sixth embodiment has a hollowed-out region, and the first metal layer 13 and the second metal layer 14 are disposed in the hollowed-out region of the non-metallic case 20. The remaining material parts are the same as those of the fifth embodiment, so they are not described here.

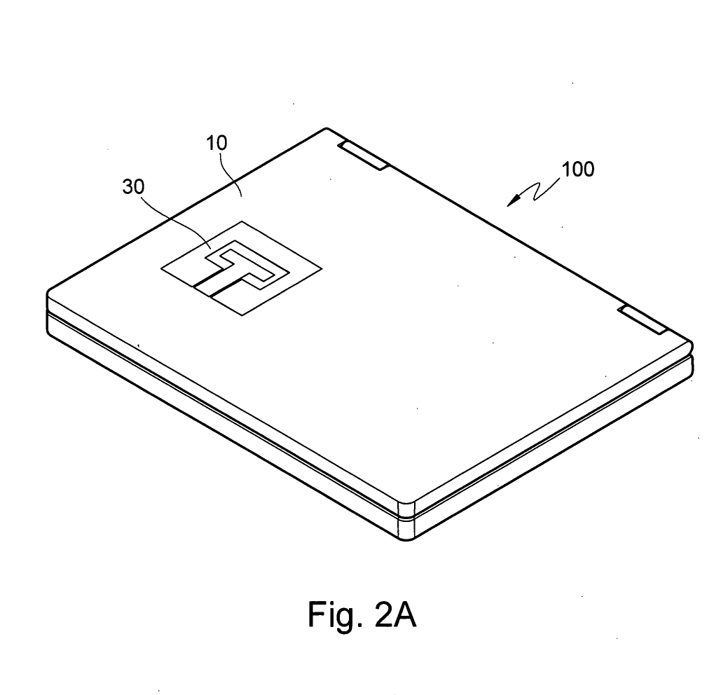

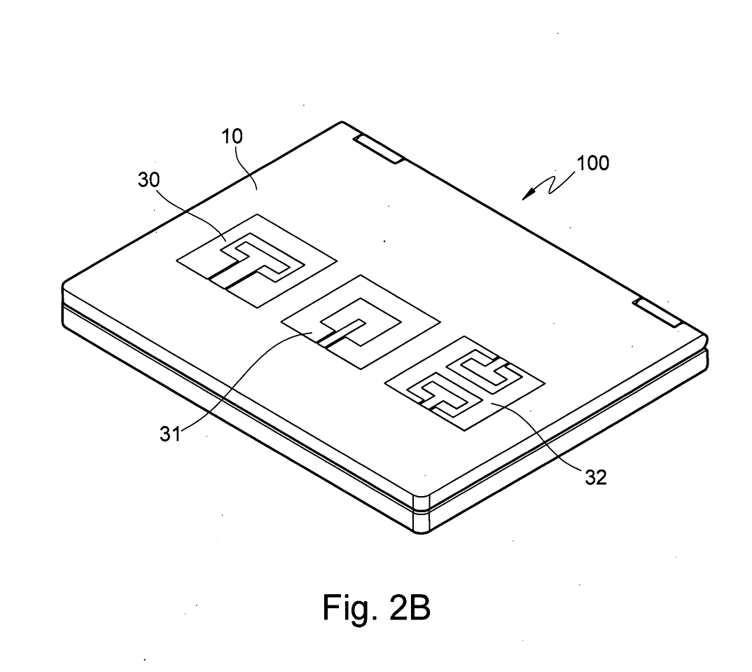

Referring to FIG. 2, a schematic view of partial appearance of the electronic device according to the embodiment of the present invention is shown. As shown in FIG. 2, the electronic device 100 of the present invention includes a first antenna 30, a second antenna 31, a third antenna 32, and a metal case 10. The metal case 10 has a part of trench pattern structure, so as to respectively form the first antenna 30, the second antenna 31, and the third antenna 32. The first antenna 30 is electrically coupled to the signal transceiver circuit of the electronic device 100, so as to transfer and receive the wireless signal of a first frequency value (for example 2.4 GHz). The second antenna 31 is electrically coupled to the signal transceiver circuit of the electronic device 100, so as to transfer and receive the wireless signal of the second frequency value (for example 900 MHZ or 1800 MHz). The third antenna 32 is electrically coupled to the signal transceiver circuit of the electronic device 100, so as to transfer and receive the wireless signal of a third frequency value (for example 5 GHz). Therefore, the trench patterns of the first antenna 30, the second antenna 31, and the third antenna 32 can be directly viewed from the appearance of the electronic device 100. The first antenna 20, the second antenna 21, and the third antenna 22 in the electronic device 100 are integrated on the metal case 10, so the internal space of the electronic device 100 is not occupied too much, and the gain of the antenna of the electronic device 100 is better than the gain of the conventional built-in antenna. According to the design requirement, the position of each antenna in the embodiment of the present invention can be disposed on any position on the metal case 10 of the electronic device 100, for example the front side or the back side.

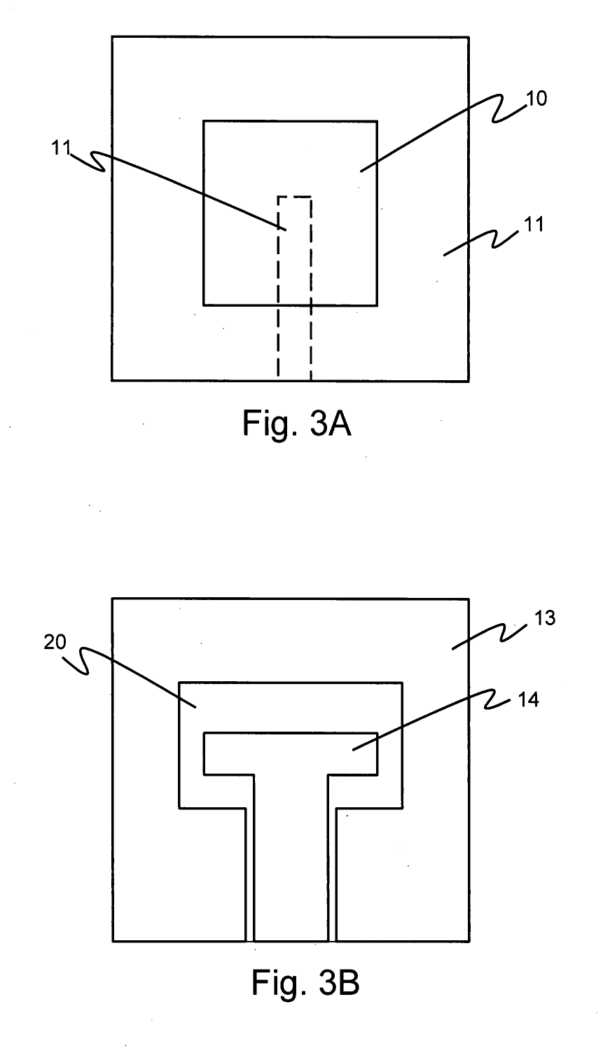

Referring to FIG. 3A, a schematic top view of the first embodiment according to the present invention is shown. As shown in FIG. 3A, the case structure of the present invention includes the dielectric layer 10, the metal case 11, and the metal layer 12. The metal case 11 serves as the antenna ground portion, and the metal layer 12 serves as the antenna signal feeding portion and the antenna radiation portion. The dielectric layer 10 is disposed between the metal layer 12 and the metal case 11, so only the dielectric layer 10 and the metal case 11 are viewed from the appearance of the electronic device 100.

Referring to FIG. 3B, a schematic top view of the fifth embodiment according to the present invention is shown. As shown in FIG. 3B, the case structure of the present invention includes the non-metallic case 20, the first metal layer 13, and the second metal layer 14. The first metal layer 13 serves as the antenna ground portion, and the second metal layer 14 serves as the antenna signal feeding portion and the antenna radiation portion. The first metal layer 13 and the second metal layer 14 are disposed on the first surface 201 of the non-metallic case 20. Therefore, the non-metallic case 20, the first metal layer 13, and the second metal layer 14 are viewed from the appearance of the electronic device 100.

Next, the site of the near field test of the present invention is an anechoic chamber with a wall surface made of metal for isolating the external signal interference. In the chamber, an electromagnetic wave absorbing material is adhered on the wall to reduce the reflecting energy in the chamber. During the measurement, the distribution of parameters (e.g., amplitude and phase) of the electromagnetic wave radiated by an antenna under test (AUT) in the near field space is detected by a receiving scanning probe (in the embodiment of the present invention, during the measurement, the distance between the AUT and the receiving scanning probe is 4 m), and the scanning manner can be plane, cylinder, or sphere. The radio frequency (or microwave) signals are transmitted to a vector network analyzer (VNA) though a coaxial cable in an electrical manner, so as to obtain the related data. After processes such as a probe radiation field pattern calibration and a Flourier numerical value transform are performed on the data, the desired AUT radiating (far field) field pattern is obtained.

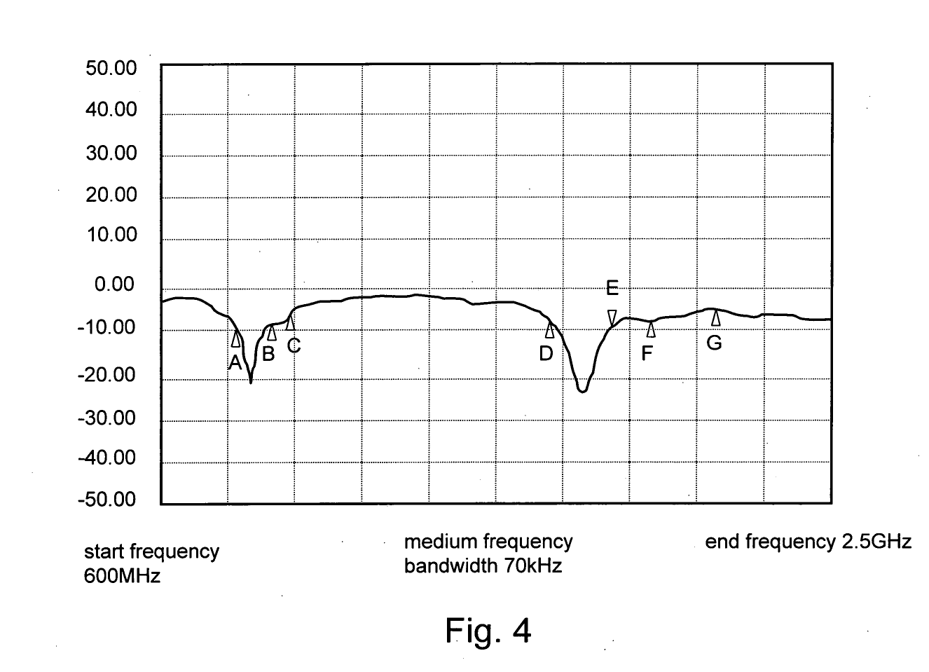

Referring to FIG. 4, a schematic view of the reflection loss according to the embodiment of the present invention is shown. The value of a reflecting parameter S11 at a test point A (the frequency is 824 MHz) is −10.129 dB, the value of the reflecting parameter S11 at a test point B (the frequency is 896 MHz) is −8.4410 dB, the value of the reflecting parameter S11 at a test point C (the frequency is 960 MHz) is −6.0026 dB, the value of the reflecting parameter S11 at a test point D (the frequency is 1.71 GHz) is −7.7216 dB, the value of the reflecting parameter S 11 at a test point E (the frequency is 1.88 GHz) is −8.3100 dB, the value of the reflecting parameter S11 at a test point F (the frequency is 1.99 GHz) is −6.8686 dB, and the value of the reflecting parameter S11 at a test point G (the frequency is 2.17 GHz) is −4.5696 dB.

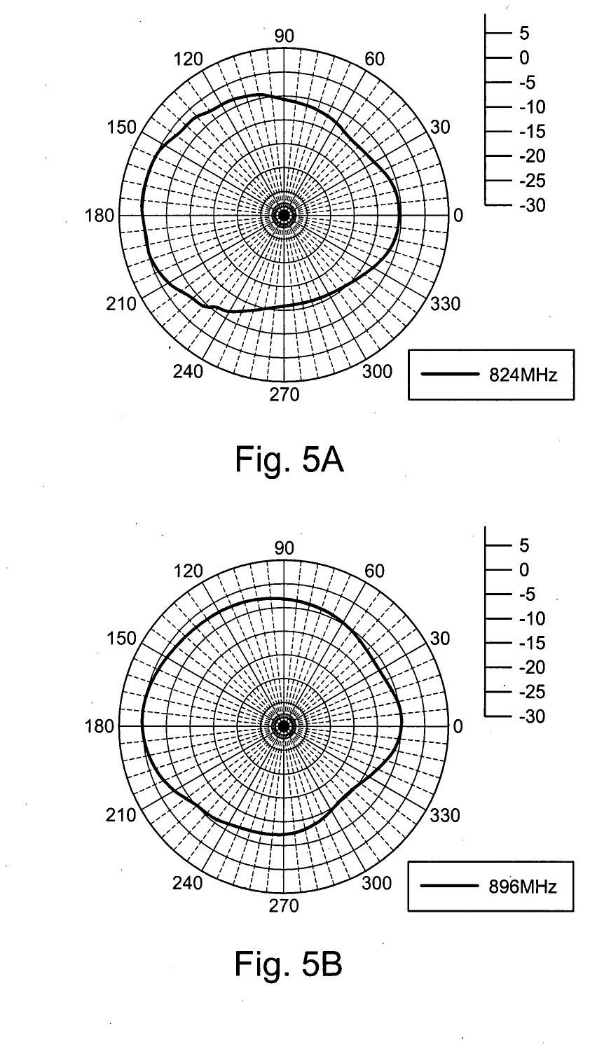

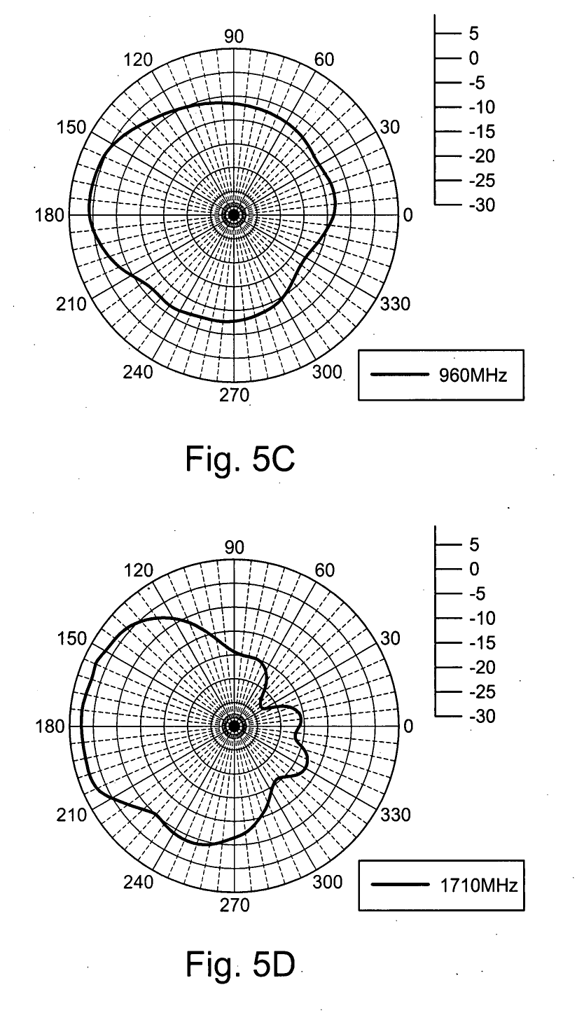

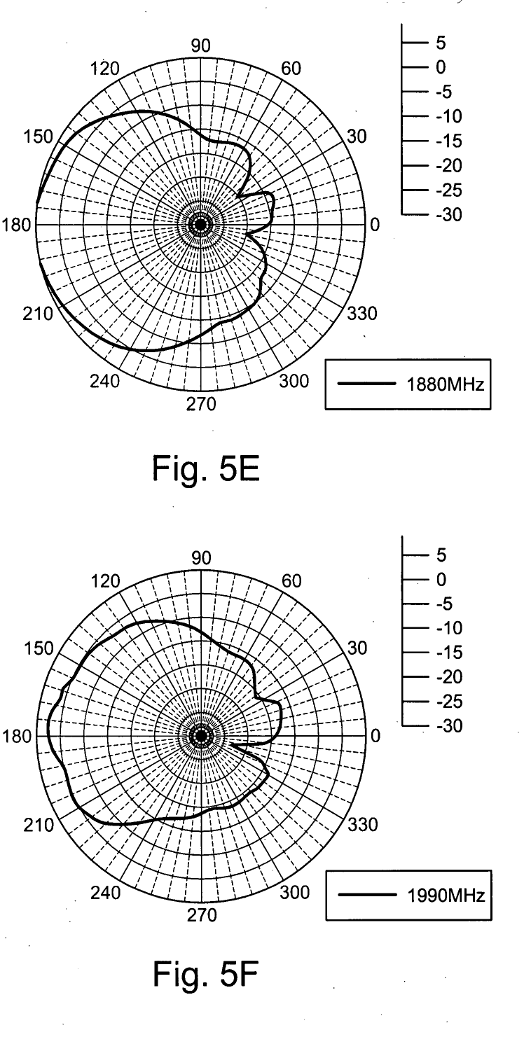

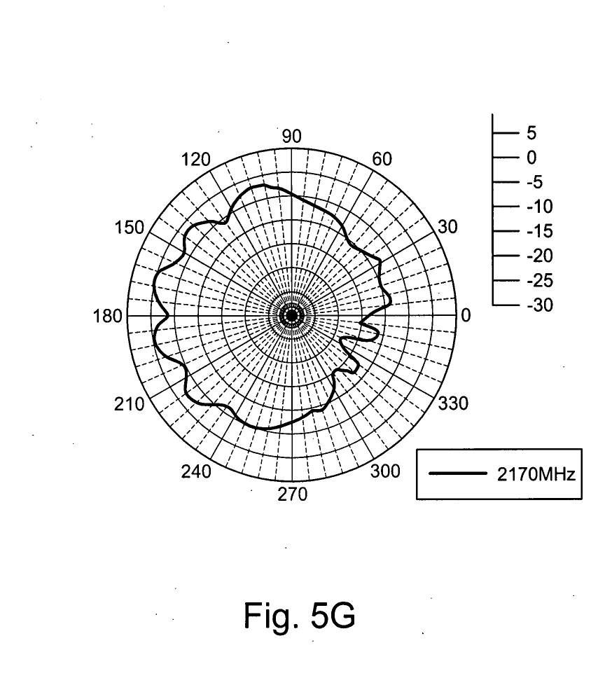

Referring to FIGS. 5A, 5B, and 5C, radiation field pattern views of an H plane according to the embodiment of the present invention are shown. The operating frequency of the global system for mobile communication (GSM) is used for test, in which the testing frequencies of GSM are 824 MHz, 896 MHz, and 960 MHz.

Referring to FIGS. 5D, 5E, 5F, and 5G, radiation field pattern views of the H plane according to the embodiment of the present invention are shown. The operating frequencies of the digital communication system (DCS) and the personal communication service (PCS) are used for test, in which the testing frequencies of DCS are 1710 MHz, 1880 MHz, and 1990 MHz, and the testing frequency of PCS is 2170 MHz. For the related gain numerical values, please refer to Table 1 as follows.

TABLE 1

| | Testing | Maximum | Minimum | Average |
|---|---|---|---|---|
| | frequency | gain | gain | gain |
| | (MHz) | (dBi) | (dBi) | (dBi) |
| H-plane | 824 | 0.81 | −11.16 | −4.07 |
| | 896 | 1.14 | −10.03 | −3.34 |
| | 960 | 0.97 | −12.01 | −4.80 |
| | 1710 | 2.89 | −25.14 | −3.06 |
| | 1880 | 6.35 | −20.30 | −0.20 |
| | 1990 | 2.36 | −22.47 | −4.39 |
| | 2170 | 0.10 | −18.42 | −5.35 |

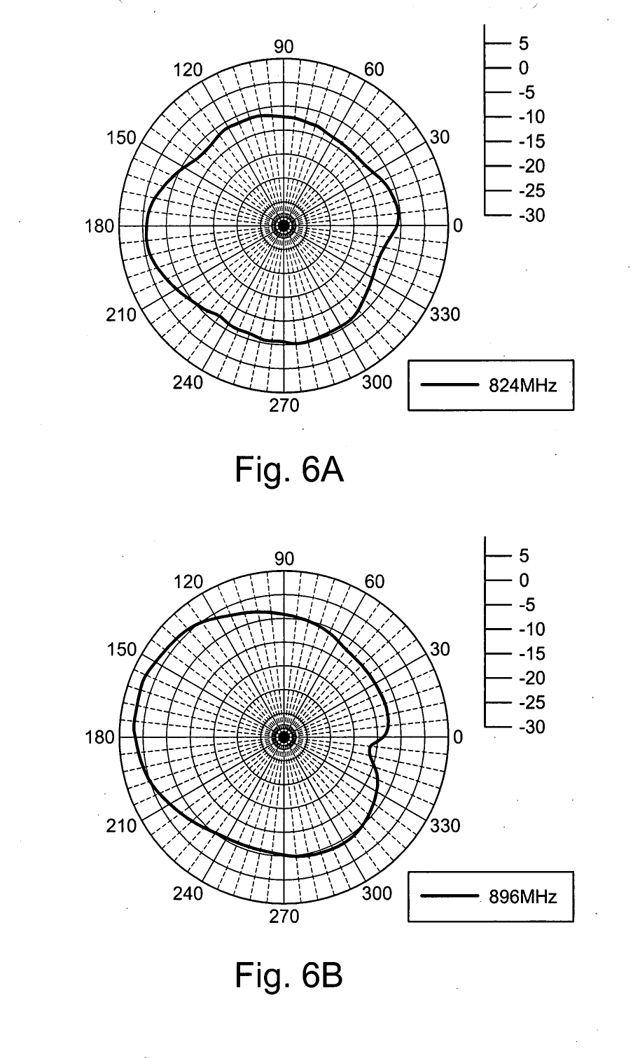

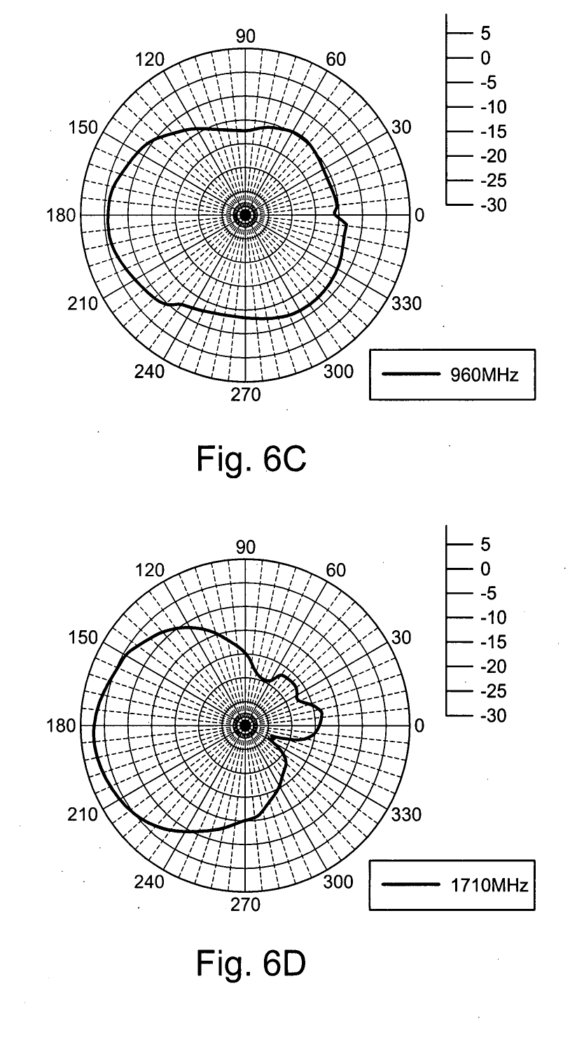

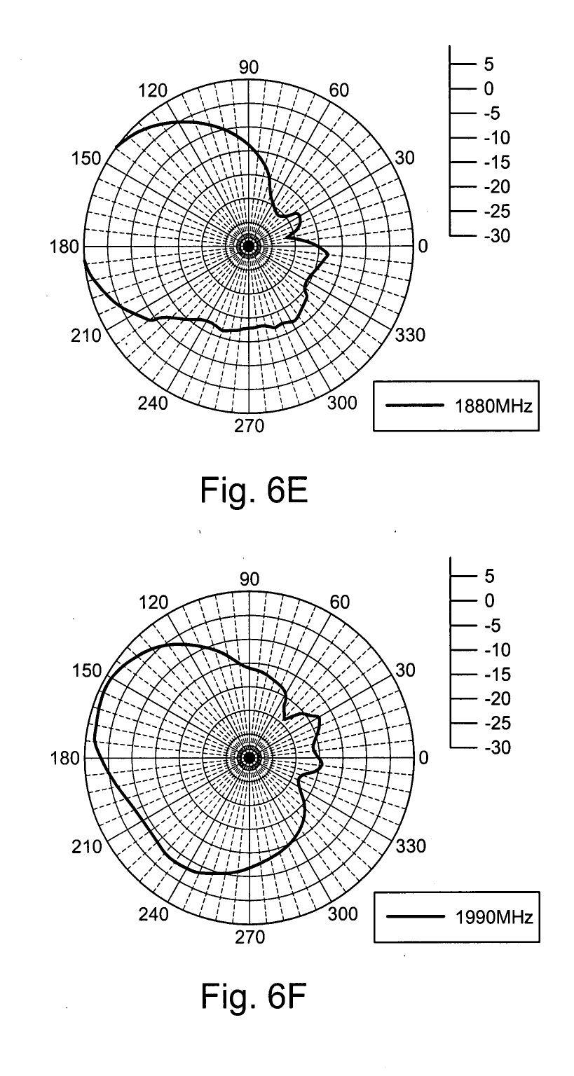

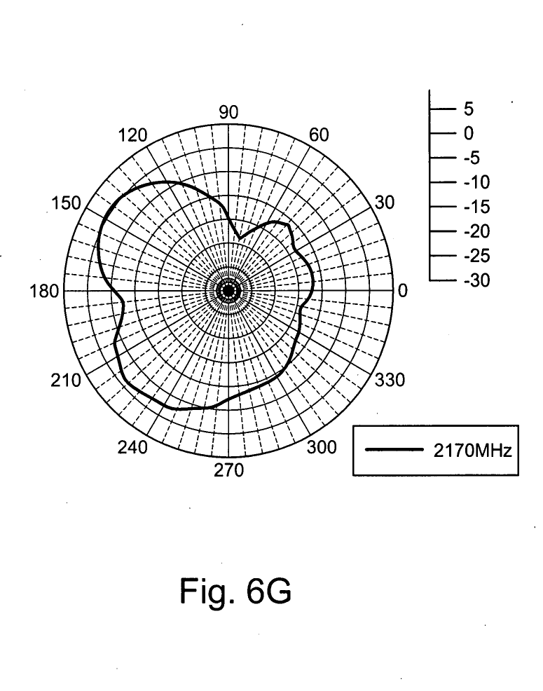

Referring to FIGS. 6A, 6B, and 6C, radiation field pattern views of an E1 plane according to the embodiment of the present invention are shown. The operating frequency of GSM is used for test, in which the testing frequencies of GSM are 824 MHz, 896 MHz, and 960 MHz.

Referring to FIGS. 6D, 6E, 6F, and 6G, radiation field pattern views of the E1 plane according to the embodiment of the present invention are shown. The operating frequencies of the DCS and the PCS are used for test, in which the testing frequencies of DCS are 1710 MHz, 1880 MHz, and 1990 MHz, and the testing frequency of PCS is 2170 MHz. For the related gain numerical values, please refer to Table 2 as follows.

TABLE 2

| | | Maximum | Minimum | Average |
|---|---|---|---|---|
| | Frequency | gain | gain | gain |
| | (MHz) | (dBi) | (dBi) | (dBi) |
| E1-plane | 824 | −0.60 | −8.54 | −5.23 |
| | 896 | 2.57 | −11.34 | −2.43 |
| | 960 | −0.33 | −12.10 | −5.56 |
| | 1710 | 2.49 | −25.36 | −4.02 |
| | 1880 | 6.89 | −21.96 | −0.72 |
| | 1990 | 4.29 | −19.15 | −3.02 |
| | 2170 | 0.92 | −18.90 | −5.04 |

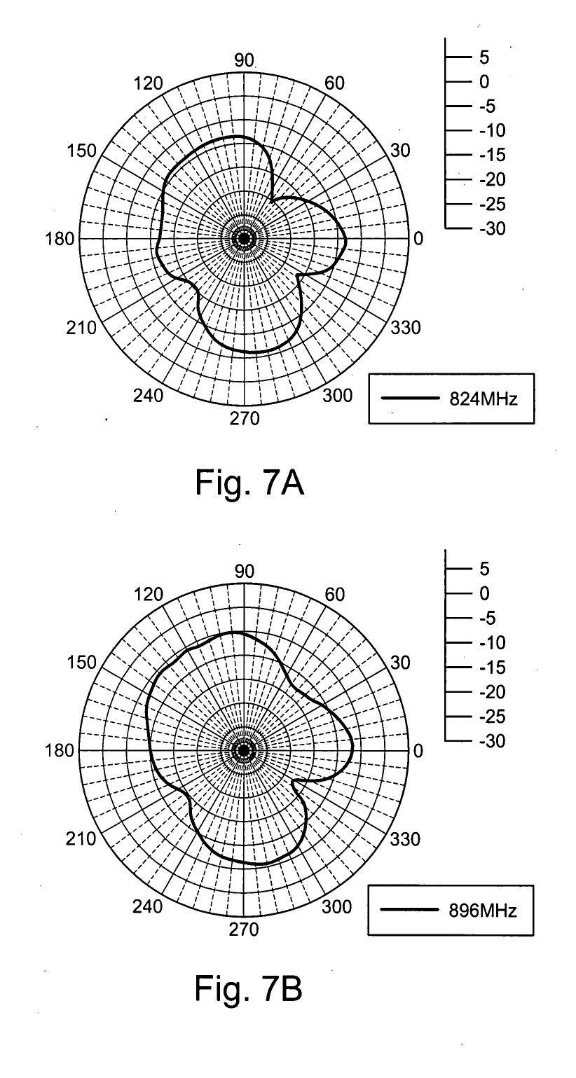

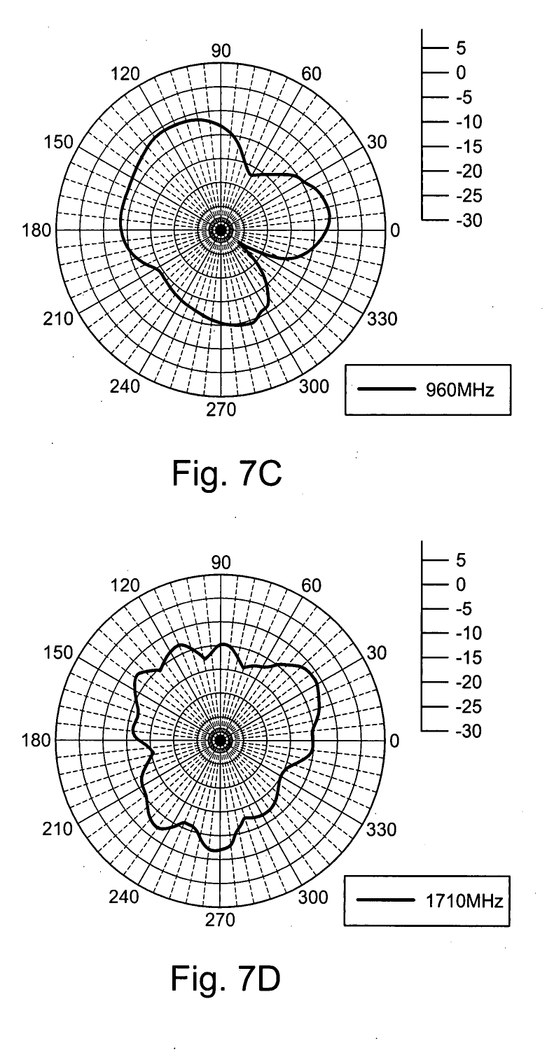

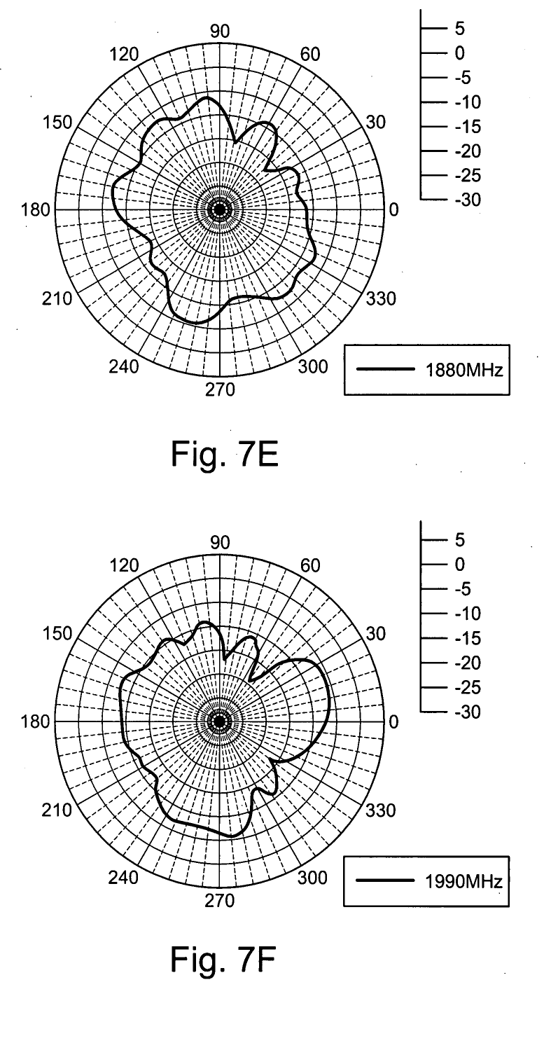

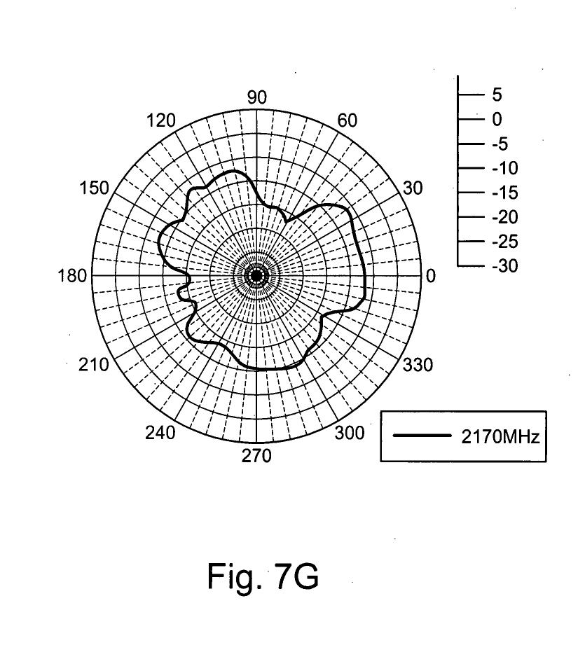

Referring to FIGS. 7A, 7B, and 7C, radiation field pattern views of an E2 plane according to the embodiment of the present invention are shown. The operating frequency of GSM is used for test, in which the testing frequencies of GSM are 824 MHz, 896 MHz, and 960 MHz.

Referring to FIGS. 7D, 7E, 7F, and 7G, radiation field pattern views of the E2 plane according to the embodiment of the present invention are shown. The operating frequencies of the DCS and the PCS are used for test, in which the testing frequencies of DCS are 1710 MHz, 1880 MHz, and 1990 MHz, and the testing frequency of PCS is 2170 MHz. For the related gain numerical values, please refer to Table 3 as follows.

TABLE 3

| | | Maximum | Minimum | Average |
|---|---|---|---|---|
| | Frequency | gain | gain | gain |
| | (MHz) | (dBi) | (dBi) | (dBi) |
| E2-plane | 824 | −5.76 | −20.29 | −10.11 |
| | 896 | −5.55 | −17.39 | −8.34 |
| | 960 | −5.64 | −26.34 | −9.69 |
| | 1710 | −6.50 | −15.52 | −10.00 |
| | 1880 | −5.20 | −17.64 | −9.21 |
| | 1990 | −5.77 | −19.08 | −9.35 |
| | 2170 | −6.50 | −17.48 | −9.88 |

To sum up, in the case structure of the electronic device of the present invention, the combination of the case and the metal layer forms the structure and an operating principle similar to the slot antenna. In appearance, the antenna of the electronic device is adhered on the case and is partially exposed. The internal space of the electronic device is not occupied too much, in addition, because of the structural property of the partial exposed antenna, the gain of the antenna of the present invention is better than the gain of the conventional built-in antenna.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A case structure of an electronic device, for accommodating an internal circuit of the electronic device, comprising:
a metal case, for holding the internal circuit and being electrically coupled to a signal transceiver circuit of the internal circuit; and
at least one trench pattern, formed on a specific region of the metal case, when the metal case is electrically coupled to the signal transceiver circuit, the metal case and the trench pattern constitute at least one antenna of the electronic device.

2. The case structure of an electronic device as claimed in claim 1, wherein each the antenna comprises:
a signal radiation portion, for radiating a signal output by the signal transceiver circuit to an exterior of the electronic device, or receiving a wireless signal from the exterior;
a signal feeding portion, electrically coupled to the signal transceiver circuit; and
a signal ground portion, disposed around the signal radiation portion to serve as a ground loop of the antenna.

3. The case structure of an electronic device as claimed in claim 2, further comprising:
a dielectric layer, formed on a surface of the metal case; and
a metal layer, formed on a surface of the dielectric layer to serve as the signal feeding portion and the signal radiation portion of the antenna.

4. The case structure of an electronic device as claimed in claim 1, wherein the trench pattern is used for matching line impedances of the antenna.

5. The case structure of an electronic device as claimed in claim 1, wherein each the antenna is a slot antenna.

6. The case structure of an electronic device as claimed in claim 1, wherein each the antenna is operated at one of GMS, DCS, and PCS frequency bands.

7. The case structure of an electronic device as claimed in claim 1, wherein the metal case is made of a single metal or an alloy material of a plurality of the single metal.

8. The case structure of an electronic device as claimed in claim 7, wherein the single metal is selected from the group consisting of titanium, aluminum, silver, copper, nickel, iron, cobalt, magnesium, and platinum.

9. A case structure of an electronic device, for accommodating an internal circuit of the electronic device, comprising:
a non-metallic case, for holding the internal circuit; and
a first metal layer, formed on a specific region of the non-metallic case, the first metal layer having at least one trench pattern, when the first metal layer is electrically coupled to the signal transceiver circuit of the internal circuit, the first metal layer constitutes at least one antenna of the electronic device.

10. The case structure of an electronic device as claimed in claim 9, wherein each the antenna comprises:
a signal radiation portion, radiating a signal output by the signal transceiver circuit to the exterior, or receiving a wireless signal from the exterior;
a signal feeding portion, electrically coupled to the signal transceiver circuit; and
a signal ground portion, disposed around the signal radiation portion to serve as a ground loop of the antenna.

11. The case structure of an electronic device as claimed in claim 10, further comprising:
a dielectric layer, formed on a surface of the metal case; and
a second metal layer, formed on a surface of the dielectric layer to serve as the signal feeding portion and the signal radiation portion of the antenna.

12. The case structure of an electronic device as claimed in claim 11, wherein the first metal layer and the second metal layer are made of a single metal or an alloy material of a plurality of the single metal.

13. The case structure of an electronic device as claimed in claim 12, wherein the single metal is selected from the group consisting of titanium, aluminum, silver, copper, nickel, iron, cobalt, magnesium, or platinum.

14. The case structure of an electronic device as claimed in claim 9, wherein the trench pattern is used for matching line impedances of the antenna.

15. The case structure of an electronic device as claimed in claim 9, wherein the antenna is a slot antenna.

16. The case structure of an electronic device as claimed in claim 9, wherein each the antenna is operated at one of GMS, DCS, and PCS frequency bands.
